(19) United States
(12) Patent Application Publication
(10) Pub. No.: US 2018/0288232 A1
(43) Pub. Date: Oct. 4, 2018

(54) VEHICULAR MOBILE DEVICE CONTROL

(71) Applicant: Ford Global Technologies, LLC, Dearborn, MI (US)

(72) Inventors: Perry Robinson MACNEILLE, Lathrup Village, MI (US); Oliver LEI, Windsor (CA)

(21) Appl. No.: 15/476,047

(22) Filed: Mar. 31, 2017

(51) Int. Cl. H04M 11/00; H04W 4/04; H04W 4/02

(52) U.S. Cl. CPC H04M 11/007; H04B 7/0617; H04W 4/023; H04W 4/046

(57) ABSTRACT

Vehicle systems and methods identify a seat-related location for a mobile device based on an angle of a signal received from the mobile device. Responsive to identifying the seat-related location for the mobile device, the vehicle systems and methods control a functional aspect of the mobile device based on the seat-related location.

### TECHNICAL FIELD

Aspects of the disclosure generally relate to systems, methods, and devices for vehicular mobile device control.

### BACKGROUND

Vehicles often include features that are well suited to be controlled by a person in one area of the vehicle, but are unsuited to be controlled by a person in another area of the vehicle. For example, when a driver enters a destination into a navigation system while the vehicle is in motion, the driver diverts his or her eyes from the road to the display of the navigation system. As a further example, a vehicle may include distinct climate zones that are each primarily for a different section of the vehicle.

### SUMMARY

The following summary may present a simplified overview of some embodiments of the invention in order to provide a basic understanding of certain aspects the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

In one exemplary embodiment, a vehicle system includes at least one processor configured to identify a seat-related location for a mobile device based on an angle of a signal received from the mobile device. Responsive to identifying the seat-related location for the mobile device, the at least one processor is further configured to permit the mobile device to control a first climate zone of the vehicle that is for the seat-related location and not a second climate zone of the vehicle.

In another exemplary embodiment, a vehicle system includes at least one processor configured to identify a seat-related location for a mobile device based on an angle of a signal received form the mobile device. The seat-related location is associated with a driver's seat of the vehicle. Responsive to identifying the seat-related location for the mobile device, the at least one processor is further configured to prevent a display of the mobile device from illuminating when the vehicle is in motion.

In a further exemplary embodiment, a method includes identifying a seat-related location for a mobile device based on an angle of a signal received from the mobile device. Responsive to identifying the seat-related location, the method includes preventing the mobile from entering a destination into a navigation system of the vehicle.

### BRIEF DESCRIPTION OF THE DRAWINGS

FIG. 1 illustrates a computing environment of a vehicle.

FIG. 2 illustrates a computer system that may be included in the vehicle computing environment of FIG. 1.

FIG. 3 illustrates an interaction between an antenna unit of the vehicle computing environment of FIG. 1 and mobile devices.

FIG. 4 illustrates an antenna element arrangement that may be implemented in the antenna unit of the vehicle computing environment of FIG. 1.

FIG. 5 illustrates an interior cabin of the vehicle.

FIG. 6 illustrates a seat map for the vehicle.

FIG. 7 illustrates a processing architecture that may be provided by the vehicle computing environment of FIG. 1.

FIG. 8 illustrates a process that may be performed by the processing architecture of FIG. 7.

FIG. 9 illustrates a technique for determining a device distance that may be performed in the process of FIG. 8.

FIG. 10 illustrates another process that may be performed by the processing architecture of FIG. 7.

### DETAILED DESCRIPTION

Embodiments described herein generally relate to systems and methods for identifying a seat-related location for a mobile device within or around a vehicle, and controlling a function of the mobile device based on the identified location. In this way, the embodiments promote efficient feature utilization and safety within the vehicle, as the identified location may be utilized to ensure that mobile devices are permitted to control those features particularly relevant to the mobile device's location, and may be utilized to ensure that mobile devices are operated in a safe manner within the vehicle.

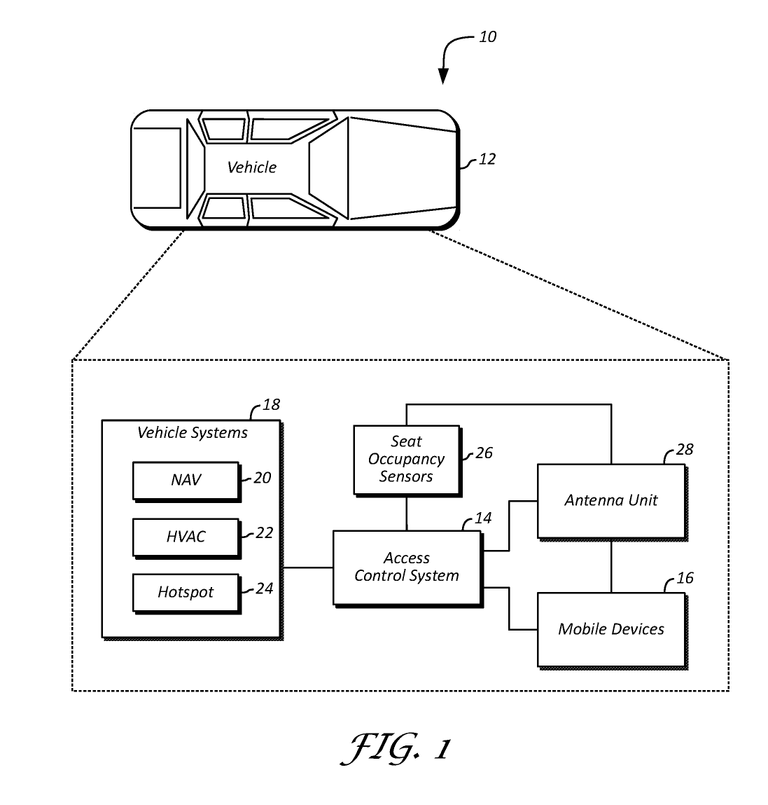

Turning to the figures, FIG. 1 illustrates an exemplary vehicle computing environment 10 of a vehicle 12. The vehicle computing environment 10 may include an access control system (“ACS”) 14, one or more mobile devices 16, one or more vehicle systems 18, seat occupancy sensors 26, and an antenna unit 28.

The ACS 14 may connect with each of the mobile devices 16. Once connected, the ACS 14 may control a function of each mobile device 16 based on an identified location of the mobile device 16. For example, the ACS 14 may enable a mobile device 16 to interact with one or more of the vehicle systems 18, and may disable or prevent one or more functions of the mobile device 16 when the vehicle 12 is in motion (e.g., disable a display of the mobile device 16). The ACS 14 may also include vehicle-integrated user controls that enable a user to utilize a function of a connected mobile device 16 (e.g., conduct a phone call, answer a text) without needing to physically touch the mobile device 16 (e.g., a hands-free system). The ACS 14 may connect to each mobile device 16 directly via Bluetooth, Wi-Fi, or a wired connection, and/or may connect to each mobile device 16 via the antenna unit 28. Exemplary mobile devices 16 may include cell phones, smart phones, PDA's, and any other like devices having network connectivity. Mobile devices 16 may also include wearables, such as trackers, smart watches, and the like, or an implanted device. Because each of these mobile devices 16 is typically kept close to its respective user, knowing the location of the mobile device 16 generally identifies the location of the user or vehicle occupant. As is further explained below, the location of a vehicle occupant within the vehicle may be utilized for controlling features of the vehicle 12, such as controlling which features are available to the occupant via his or her mobile device 16, and safety features associated with the occupant's mobile device 16.

The vehicle systems 18 may include computers, sensors, actuators, and devices that provide various convenience features of the vehicle 12. In the illustrated embodiment, the vehicle systems 18 include a navigation system 20, a vehicle heating, ventilation, and air conditioning (HVAC) system 22, and a hotspot system 24. A user may access and manipulate one or more of these systems through a mobile device 16 connected to the ACS 14. For example, a connected mobile device 16 may include an interface or app that allows a user to enter a destination into the navigation system 20, control one or more climate zones offered by the HVAC system 22, or access an Internet connection maintained by the hotspot system 24.

The seat occupancy sensors 26 may detect when a person sits on or gets off of a seat of the vehicle 12. In some embodiments, the seat occupancy sensors 26 may include several weight sensors, where one or more weight sensors are coupled to each seat of the vehicle 12. The weight sensors coupled to a particular seat may detect when weight is increased or decreased on the seat, and may transmit a corresponding signal to the ACS 14 or the antenna unit 28 indicating that a weight increase or decrease has occurred.

The antenna unit 28 may facilitate determining a location of each mobile device 16 within the vehicle 12. Tracking the location of each of the mobile devices 16 within the vehicle 12 may be desirable in several situations. For example, when a mobile device 16 is located in the driver's seat location of the vehicle 12, it may be desirable from a safety perspective to prevent the display of the mobile device 16 from being active, especially while the vehicle 12 is in motion, which may force the driver to interact with the integrated controls of the ACS 14 to utilize functions of the mobile device 16. As another example, when a mobile device 16 is located in one of the plurality of climate zones offered by the HVAC system 22, then it may be desirable to limit the mobile device 16 to controlling only that climate zone in which the mobile device 16 is located. In yet a further example, when the seats of the vehicle 12 are reserved for particular passengers scheduled on particular itineraries, then it may be desirable to track the mobile device 16 of each passenger to ensure that for each passenger, the passenger's mobile device 16 enters the vehicle 12 at the beginning of the passenger's itinerary, is not located in a seat assigned to another passenger during the passenger's itinerary, and exits the vehicle 12 at the end of the passenger's itinerary. Moreover, the location of certain passengers and other vehicle occupants within the vehicle 12 may be important for safety reasons (e.g., to assist those with specific needs, to provide access to certain vehicle features to authorized users only).

Accordingly, the vehicle computing environment 10 may be configured to utilize the antenna unit 28 to determine a location of each mobile device 16 within or around the vehicle 12. Specifically, when the vehicle 12 is powered on and/or operating, the seat occupancy sensors 26 may detect that weight has been increased for one of the seats of the vehicle 12. The seat occupancy sensors 26 may send a corresponding signal to the antenna unit 28, or alternatively to the ACS 14, which may thereafter send a corresponding signal to the antenna unit 28, either over a wireless or wired connection. Responsive to receiving the signal of the weight increase, the antenna unit 28 may transmit an electromagnetic wave throughout a cabin of the vehicle 12, and collect measurement data for one or more mobile devices 16 present in the vehicle 12 based on thereon. Upon collecting the measurement data, the antenna unit 28 may identify a seat-related location of each mobile device 16 within the vehicle 12 based on the measurement data, and transmit the determined location to the ACS 14. Alternatively, the antenna unit 28 may transmit the measurement data to the ACS 14, which may then identify a seat-related location for each mobile device 16 based thereon.

After the seat-related location of each mobile device 16 within the vehicle 12 is determined, the ACS 14 may control a function of each mobile device 16 based on the mobile device's 16 determined location. For example, the ACS 14 may transmit one or more signals to a mobile device 16, such as via Bluetooth, Wi-Fi, and/or the antenna unit 28, that enables the mobile device 16 to control the climate zone in which the mobile device 16 is located, and/or that limits the mobile device 16 from controlling any other climate zones. As a further example, the ACS 14 may prevent a display of a mobile device 16 from illumining when the vehicle 12 is in motion, such as via a corresponding signal sent to the mobile device 16 via Bluetooth, Wi-Fi, and/or the antenna unit 28, if the mobile device 16 is located in a driver's seat location or zone rather than a passenger seat location or zone of the vehicle 12. These and other features are discussed in greater detail below.

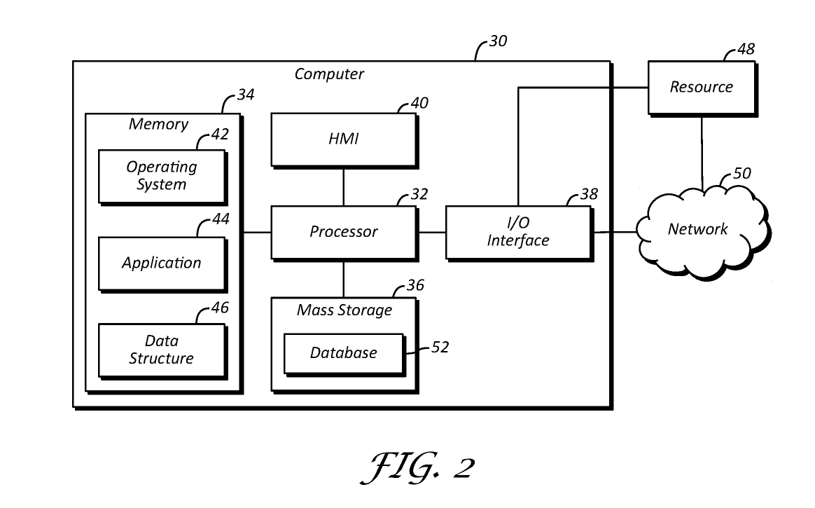

Referring to FIG. 2, the ACS 14, the mobile devices 16, the vehicle systems 18, and the antenna unit 28 may be implemented by one or more computing systems, such as exemplary computer system 30. The computer system 30 may include a processor 32, a memory 34, a mass storage memory device 36, an input/output (I/O) interface 38, and a Human Machine Interface (HMI) 40.

The processor 32 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 34. The memory 34 may include a single memory device or a plurality of memory devices including, but not limited, to read-only memory (ROM), random access memory (RAM), volatile memory, non-volatile memory, static random access memory (SRAM), dynamic random access memory (DRAM), flash memory, cache memory, or any other device capable of storing information. The mass storage memory device 36 may include one or more data storage devices such as a hard drive, optical drive, tape drive, non-volatile solid state device, or any other device capable of storing information.

The processor 32 may operate under the control of an operating system 42 that resides in the memory 34. The operating system 42 may manage computer resources so that computer program code embodied as one or more computer software applications, such as an application 44 residing in memory 34, may have instructions executed by the processor 32. In an alternative embodiment, the processor 32 may execute the application 44 directly, in which case the operating system 42 may be omitted. One or more data structures 46 may also reside in memory 34, and may be used by the processor 32, operating system 42, or application 44 to store or manipulate data.

The computer system 30 may be operatively coupled to one or more external resources 48 via the I/O interface 38 and/or network 50. External resources 48 may include, but are not limited to, servers, systems, databases, mass storage devices, peripheral devices, cloud-based network services, or any other suitable computer resource that may be used by the computer system 30. For example, relative to the ACS 14, external resources 48 may include the vehicle systems 18, the seat occupancy sensors 26, the antenna unit 28, and/or the mobile devices 16. Relative to the antenna unit 28, external resources 48 may include the mobile devices 16, the seat occupancy sensors 26, the ACS 14, and/or the vehicle systems 18. The network 50 may include one or more cellular towers, local area networks, wide area networks, and the Internet.

The I/O interface 38 may provide a machine interface that operatively couples the processor 32 to other devices and systems, such as the network 50 and/or the one or more external resources 48. To this end, the I/O interface 38 may include I/O ports for wired connections, and may include a Bluetooth antenna, a Wi-Fi antenna, a cellular antenna, and/or other like wireless technology for establishing wireless connections. In some embodiments, the ACS 14 and antenna unit 28 may connect over Wi-Fi, and the ACS 14 and mobile devices 16 may connect over Wi-Fi, Bluetooth, and/or the antenna unit 28.

The application 44 may work cooperatively with the network 50 and/or the external resources 48 by communicating via the I/O interface 38 to provide the various features, functions, applications, processes, or modules comprising embodiments of the invention. The application 44 may also have program code that is executed by the one or more external resources 48, or otherwise rely on functions or signals provided by other system or network components external to the computer system 30. Indeed, given the nearly endless hardware and software configurations possible, persons having ordinary skill in the art will understand that embodiments of the invention may include applications that are located externally to the computer system 30, distributed among multiple computers or other external resources 48, or provided by computing resources (hardware and software) that are provided as a service over the network 50, such as a cloud computing service.

The HMI 40 may be operatively coupled to the processor 32 of computer system 30 to allow a user to interact directly with the computer system 30. The HMI 40 may include video or alphanumeric displays, a touch screen, a speaker, and any other suitable audio and visual indicators capable of providing data to the user. The HMI 40 may also include input devices and controls such as an alphanumeric keyboard, a pointing device, keypads, pushbuttons, control knobs, microphones, etc., capable of accepting commands or input from the user and transmitting the entered input to the processor 32. For example, the HMI 40 may include the vehicle-integrated user controls of the ACS 14 that enable a user to utilize a function of a connected mobile device 16 without needing to physically touch the mobile device 16. The HMI 40 may also include similar vehicle-integrated controls for interacting with one or more of the vehicle systems 18.

A database 52 may reside on the mass storage memory device 36, and may be used to collect and organize data used by the various systems and modules described herein. The database 52 may include data and supporting data structures that store and organize the data. In particular, the database 52 may be arranged with any database organization or structure including, but not limited to, a relational database, a hierarchical database, a network database, or combinations thereof. A database management system in the form of a computer software application executing as instructions on the processor 32 may be used to access the information or data stored in records of the database 52 in response to a query, where a query may be dynamically determined and executed by the operating system 42, other applications 44, or one or more modules.

FIG. 3 illustrates an exemplary embodiment of the antenna unit 28. The antenna unit 28 may include an antenna controller 62 and a multi-beam forming antenna, such as a phased array antenna 64. The phased array antenna 64 may include a plurality of receiver/transmitter circuits 66 and a plurality of antenna elements 68. Each antenna element 68 may be coupled to a receiver/transmitter circuit 66, and may include conductive material for radiating and receiving electromagnetic radiation.

Each receiver/transmitter circuit 66 and antenna element 68 combination may be half-duplex, and the antenna controller 62 may switch each receiver/transmitter circuit 66 and antenna element 68 combination between a receive mode and a transmit mode very rapidly. The phased array antenna 64 may likewise operate each receiver/transmitter circuit 66 and antenna element 68 at different frequencies and at different phases, and may switch these operational values very rapidly. More specifically, each of the combinations may have a local oscillator that can be phased locked with local oscillators in adjacent combinations. This phase locking mechanism maintains an adjustable phase difference between antenna elements 68 that controls whether the antenna 64 transmits a parallel, diverging, or converging beam and controls the direction the beam is steered. The gain of the phased array antenna 64 may also depend on the number of receiver/transmitter circuit 66 and antenna element 68 combinations used in a same mode and frequency. Similarly, the shape (e.g., slice or a ray) of an electromagnetic wave or beam transmitted from the phased array antenna 64 or of a receiving area of a directed receiver implemented via the phased array antenna 64 may depend on the pattern of receiver/transmitter circuit 66 and antenna element 68 combinations utilized in a same mode and same frequency.

When operating in the transmit mode, each of one or more of the receiver/transmitter circuit 66 and antenna element 68 combinations may act as a transmitter, and the antenna controller 62 may cause each transmitter to transmit an electromagnetic wave at a specified frequency and coordinated phase shift such that the transmitted signals combine to form one or more beams 70. Each beam 70 may include a carrier signal, which may have been modulated by the antenna controller 62 with a coded signal, such as from the ACS 14. The beams 70 offer security advantages over omni-directions signals. For example, when an omni-directional signal radiates from within a vehicle, an attacker could potentially perform a man-in-the middle attack by utilizing a device outside of the vehicle 12, such as in an adjacent vehicle. However, because each beam 70 is sent directly from the antenna 64 to a mobile device 16 within the vehicle 12, it is difficult for an attacker to place a device that intercepts the signal. The antenna controller 62 may also cause each transmitter to transmit a signal at a specified frequency and coordinated phase shift such that the phased array antenna 64 broadcasts a multi- or omni-directional signal (e.g., reference signal 72), which has a hemispherical pattern in the illustrated embodiment, throughout a cabin of the vehicle 12.

When operating in the receive mode, one or more of the receiver/transmitter circuit 66 and antenna element 68 combinations may act as receivers, and the antenna controller 62 may cause each receiver to tune to a particular carrier frequency and coordinated phase shift such that a directional receiver is formed. Specifically, by applying coordinated phase shifts to signals of a same frequency that are received by the receivers, combining the received signals, and analyzing the combined signal (e.g., checking signal strength), the antenna controller 62 may determine whether a mobile device 16 is transmitting a signal from a particular direction relative to the phased array antenna 64. Modifying the phase shifts applied to the signals received by the antenna elements 68 enables the antenna unit 28 to search for signals coming from different directions, and thereby to quickly scan different portions of the vehicle 12 for incoming signals. When operating in the receive mode, the antenna controller 62 may extract a coded signal from a carrier signal received from a mobile device 16, and thereafter transmit the coded signal to the ACS 14.

Utilization of a beam forming antenna such as the phased array antenna 64 in the antenna unit 28 enables the antenna unit 28 to operate as an omnidirectional transmitter/receiver, and as one or more directed transmitter/receivers that may each be directed towards a different portion of the vehicle 12 without the utilization of mechanical motors for moving the antenna unit 28 towards the various portions. Consequently, the phased array antenna 64 is well-suited for utilization in an interior cabin of a vehicle 12, where durability is desired and space for such an item is limited.

The antenna unit 28 and the mobile devices 16 may each be configured to operate within the extremely high frequency (EHF) frequency band and/or within a millimeter band. In other words, each of the antenna unit 28 and the mobile devices 16 may be capable of transmitting and receiving millimeter waves, or waves having wavelengths measured in millimeters (e.g., wavelengths between one and ten mm). In one exemplary embodiment, the antenna unit 28 and the mobile devices 16 may be configured to operate within the 60 GHz band in accordance with the WiGig protocol. The mobile devices 16 may each include a WiGig antenna 74 for this purpose. The mobile devices 16, or more particularly the WiGig antenna 74 of each mobile device 16, may be or include a beam-forming antenna, such as a phased array antenna similar to the phased array antenna 64. In this way, the mobile devices 16 may likewise transmit beams (e.g., a directional mobile device beacon 71) in particular directions and/or transmit an omni-directional signal (e.g., an omni-directional device beacon 76).

Operating at the aforementioned frequencies is well suited for the vehicle computing environment 10. Specifically, the size of an antenna for transmitting and receiving electromagnetic radiation, and the amount of spacing between adjacent antenna elements 68 of the antenna 64, is generally proportional to the wavelength of the signal generated by the antenna 64. Accordingly, by operating in the 60 GHz band, the size of the antenna 64 may be smaller, such as about seventy millimeters per side, relative to wireless protocols operating at lower frequencies (e.g., Wi-Fi, Bluetooth), which reduces the overall size of the antenna unit 28. In this way, when the antenna unit 28 is placed in the cabin of the vehicle 12, it will not occupy as much space and thereby be less noticeable and less obtrusive to the passengers of the vehicle 12. Antenna size becomes an even bigger consideration when the antenna 64 is to support multiple beams 70 by dividing the antenna elements 68 of the antenna 64 into subsets, each generating a beam 70 in a different direction. Furthermore, the shorter wavelength of signals generated in the 60 GHz band is well-suited for a cabin of a vehicle 12, as such signals are less prone to interference and reflection caused by physical elements within cabin. Operating within 60 GHz band also reduces interference caused by other electromagnetic signals, such as Wi-Fi signals and Bluetooth signals, that are also present in the vehicle 12. Correspondingly, normal Wi-Fi and Bluetooth connections between the ACS 14 and the mobile devices 16 may be maintained while the antenna unit 28 operates.

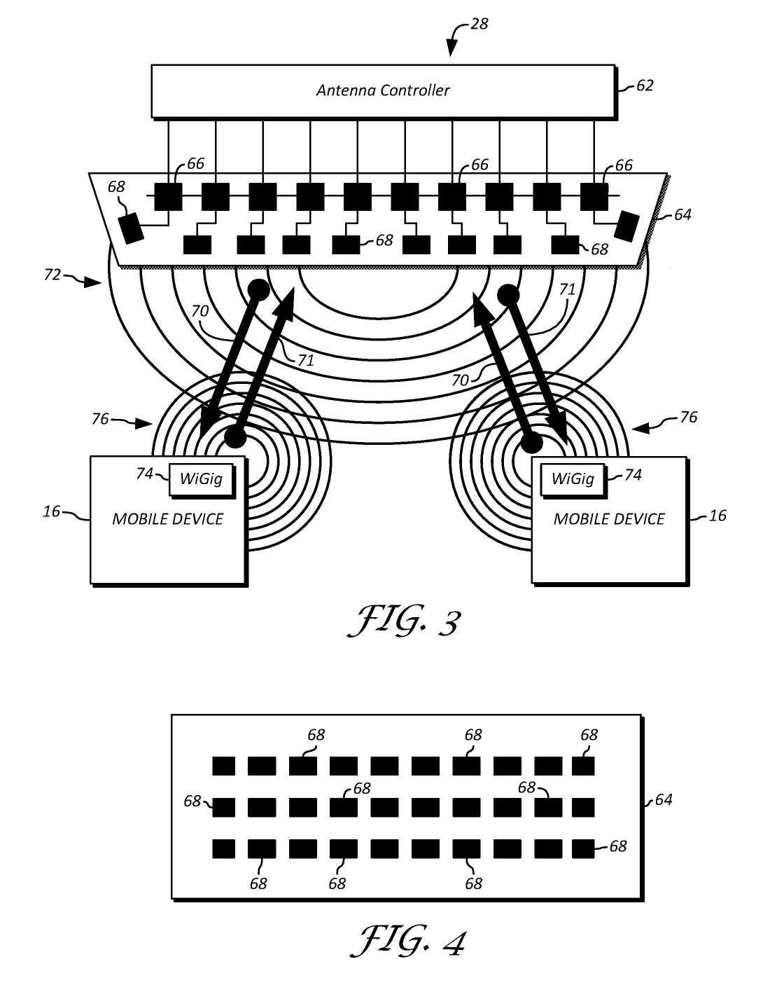

FIG. 4 illustrates an arrangement of the antenna elements 68 within the phased array antenna 64. As shown in the illustrated embodiment, the antenna elements 68 may be arranged in a matrix so as to be able to transmit and receive signals in various directions in a three-dimensional space. In the illustrated embodiment, the antenna elements 68 are evenly spaced within a same plane. However, in other embodiments, the antenna elements 68 may be irregularly spaced and/or located in different planes. As previously illustrated (but not shown in FIG. 4), each of the antenna elements 68 may be coupled to a receiver/transmitter circuit 66, which is illustrated in FIG. 3.

The coordinated phase shifts needed to transmit a beam 70 in a particular direction or to form a receiver in a particular direction may be determined using the following formula (the formula is the same for both transmitting and receiving by the principle of reciprocity):

AF(θ,ϕ)=w^{T}v(k)

where AF (θ,ϕ) is the gain of the phased array antenna 64 in the direction (θ,ϕ) relative to the phased array antenna 64, w is a weight vector that includes a complex number for a relative phase shift for each antenna element 68, and v(k) is a steering vector for the phased array antenna 64. θ may be the azimuth angle relative to the phased array antenna 64, and ϕ may be the zenith angle relative to the phased array antenna 64. To determine the phase shifts for transmitting or receiving a signal in the direction of (θ,ϕ), the weight vector w that maximizes AF (θ,ϕ) may be computed. Several methods may be utilized to compute the weights, such as Dolph-Chebyshev, Minimum Mean-Square Error, and Least-Mean-Square. The weights, or more particularly the relative phase shifts, may be computed during operation of the vehicle 10, or may be computed and stored in advance for various directions, as is further explained below.

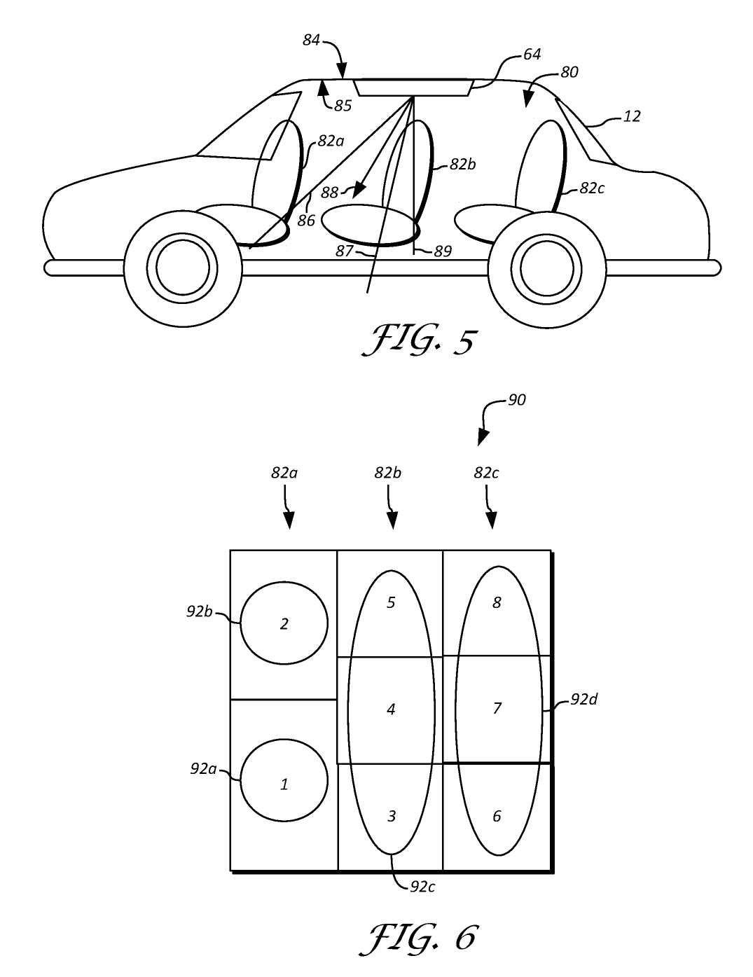

FIG. 5 illustrates an interior cabin 80 of the vehicle 12. The interior cabin 80 may include a plurality of seats. In the illustrated embodiment, the interior cabin 80 includes a plurality of seats arranged in rows, namely a front row 82a, a middle row 82b, and a back row 82c. Interior cabin 80 may also include at least a portion of the antenna unit 28. At least the phased array antenna 64 of the antenna unit 28, and possibly the antenna controller 62, may be mounted to a roof 84 of the vehicle 12 such that the phased array antenna 64 is located within the interior cabin 80 of the vehicle 12 and/or above each seat of the vehicle 12. To this end, at least the phased array antenna 64 may be mounted within a headliner 85 of the vehicle 12. Although the illustrated embodiment shows three seat rows, other seating arrangements are also possible. For example, the vehicle 12 may be a shuttle or school bus that has many rows of seats, or a vehicle 12 having one or two rows of seats. For each configuration of vehicle 12, an antenna 64 of the vehicle 12 may be designed based on the configuration of the vehicle 12 so as to be able to recognize mobile devices 16 in discrete areas of the vehicle 12.

FIG. 5 also illustrates an exemplary operation of the phased array antenna 64. In the illustrated embodiment, the phased array antenna 64 is transmitting a diverging beam represented by lines 86 and 87 towards an area adjacent to middle row 82b (e.g., seat zone 92c in FIG. 6). In this way, the information communicated from the phased array antenna 64 may only be received by mobile devices 16 in the adjacent area. The angle of the beam represented by lines 86 and 87 may be the angle between line 88 and line 89. In a similar fashion, the phased array antenna 64 may scan for signals in the same area by implementing a receiving antenna in the same direction (with the same angle).

FIG. 6 illustrates a seat map 90 representative of the seats and seat zones included in the vehicle 12. Each seat zone may include one or more seats, may correspond to or be included in one of a plurality of climate zones offered by the HVAC system 22, and may be associated with one or more limitations and/or allowances relative to mobile devices 16 located in the seat zone, as is explained in further detail below. In the illustrated embodiment, the seat map 90 includes three rows of seats, namely front row 82a, middle row 82b, and back row 82c. Each seat of the seat map 90 is associated with an identifier from 1 to 8. The front row 62a may include at least two seat zones 92a, 92b, where seat zone 92a includes seat 1 and is associated with the driver (i.e., a driver's seat zone/location), and seat zone 92b includes seat 2 and is associated with a front seat passenger (i.e., a front passenger seat zone/location). The remaining rows 82b, 82c may each include a seat zone 92c, 92d respectively. Seat zone 92c may include all of the seats of middle row 82b (e.g., seats 3, 4, 5), and seat zone 92d may include all of the seats of back row 82c (e.g., seats 6, 7, 8). Of course, other seat zone arrangements are also possible. For example, each seat of the vehicle 12 may be considered as a separate seat zone.

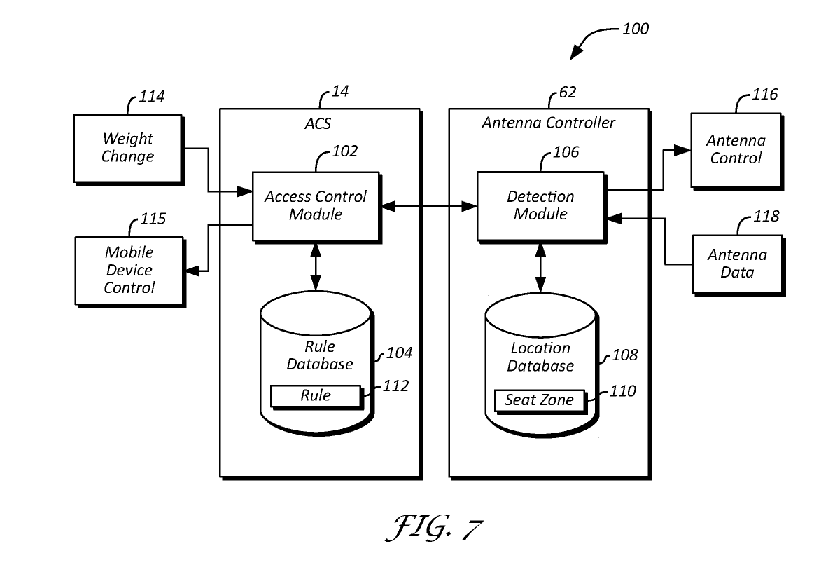

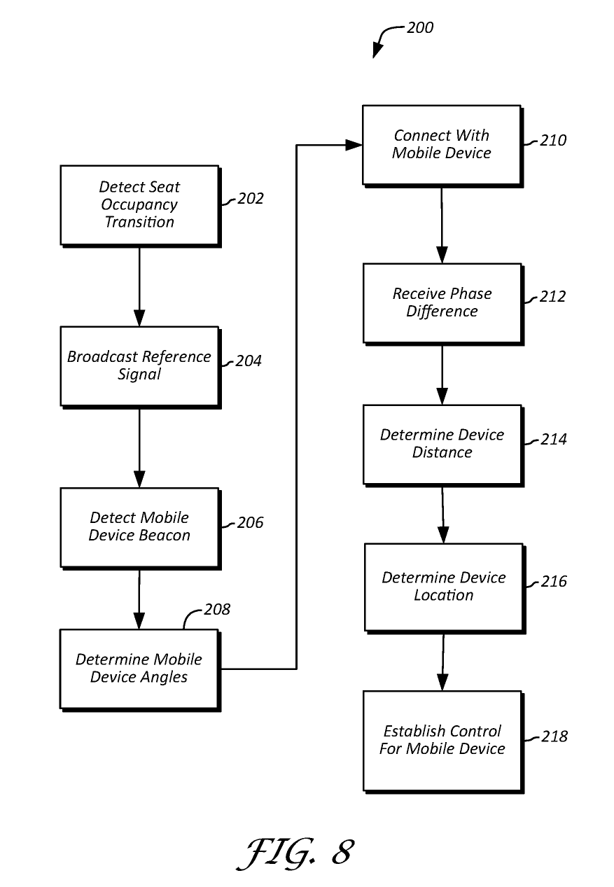

FIG. 7 illustrates a processing architecture 100 that may be provided by the vehicle computing environment 10 of FIG. 1. The processing architecture 100 may include an access control module 102 coupled to a rule database 104, and a detection module 106 coupled to a location database 108. In the illustrated embodiment, the access control module 102 and rule database 104 are provided by the ACS 14, and the detection module 106 and location database 108 are provided by the antenna controller 62. More particularly, referring to FIG. 2, access control module 102 (and the functions thereof) may be provided by one or more applications 44 on the ACS 14, the rule database 104 may be a database 52 of the ACS 14, detection module 106 (and the functions thereof) may be provided by one or more applications 44 of the antenna controller 62, and location database 108 may be a database 52 of the antenna controller 62. Alternatively, or in addition, each of the access control module 102, rule database 104, detection module 106, and location database 108 may be provided by one or more other systems of the vehicle computing environment 10. For example, at least a portion of the detection module 106 and the location database 108 may be provided by the ACS 14. In other words, at least some of the functions performed by the detection module 106 may be performed by the ACS 14, and at least some of the functions performed by the access control module 102 may be performed by the antenna controller 62.

The location database 108 may include a plurality of records, each of the records including a seat zone 110 of the vehicle 12, such as one of seat zones 92a-92d (FIG. 6). Each of the seat zones 110 may represent a discrete area of the vehicle 12 and may be associated with certain allowances and/or limitations (e.g., navigation control allowable via a mobile device 16 located in a given seat zone 110, control of a particular climate zone allowable via a mobile device 16 when located in a particular seat zone 110). In other words, the seat zones 110 may represent a geo-fencing scheme that separates various areas of the vehicle, such as an area around the driver's seat, a front passenger's seat, a backseat, a rear left passenger seat, a cell phone tray, etc.

Each record of the location database 108 may include one or more location-related properties associated with the seat zone 110 of the record relative to the phased array antenna 64. The location-related properties may indicate the boundary of each geofence associated with the vehicle 12, and more particularly, may include one or more measurement metrics relative to the phased array antenna 64. In one embodiment, the location-related properties associated with each seat zone 110 may include one or more angles for the seat zone 110 relative to the phased array antenna 64, such as one or more azimuth angles and/or zenith angles for the seat zone 110, and/or one or more distance values for the seat zone 110 relative to the phased array antenna 64. Any mobile device 16 that is measured to be at an angle and/or distance matching the location-related properties associated with a given seat zone 110 may be considered as being within the seat zone 110. In this way, the detection module 106 may determine measurement data for a mobile device 16 relative to the phased array antenna 64, such via causing the phased array antenna 64 to transmit one or more electromagnetic waves to the mobile device 16, and thereafter query the location database 108 to determine if the measurement data matches the angles and/or distance associated with one of the seat zones 110 included in the location database 108. If so, then the detection module 106 may determine that the mobile device 16 is located in the matching seat zone 110. If not, then the detection module 106 may determine that the mobile device 16 is located outside of the vehicle 12.

For example, referring back to FIGS. 5 and 6, the seat zone 92c that includes seats 3, 4, and 5 may be associated within the location database 108 with the angle between line 88 and line 89. Hence, responsive to the detection module 106 implementing a receiving antenna at the angle between line 88 and line 89 and thereafter detecting a signal from a mobile device 16 via the receiving antenna, the detection module 106 may query the location database 108 and identify that the mobile device 16 is located in the seat zone 92c of the vehicle 12.

In some embodiments, the location database 108, or some other database accessible by the detection module 106, may include one or more antenna configurations (e.g., one or more sets of coordinated phase shifts) for each seat zone 110, each antenna configuration corresponding to at least one of the angles associated with the seat zone 110. In this way, to search within or communicate with mobile devices 16 within a particular seat zone 110, the detection module 106 may query and implement the one or more antenna configurations associated with the seat zone 110. In alternative embodiments, the detection module 106 may calculate the one or more antenna configurations for each seat zone 110 based on the angles associated with the seat zone 110 during regular operation of the vehicle 12.

The rule database 104 may likewise include a plurality of records, each of the records including a different one of the seat zones 110 and a rule 112. Each rule 112 of a record may include one or more restrictions and/or one or more allowances for the seat zone 110 of the record. For example, a vehicle 12 may include a plurality of climate zones, and each rule 112 may include one of the climate zones. In other words, for a given seat zone 110, a rule 112 may indicate that a mobile device 16 located in that seat zone 110 should be able to control the climate zone associated with the seat zone 110 and not the other climate zones of the vehicle 12. As another example, for a seat zone 110 that includes a driver's seat location, an associated rule 112 may indicate that the display of each mobile device 16 in the seat zone 110 should be disabled when the vehicle 12 is in motion. Once a seat-related location (e.g., seat zone 110) is identified for a mobile device 16, the access control module 102 may query the rule database 104 based on the identified seat zone 110, and thereafter receive an identification of the rule 112 in the record that includes the seat zone 110. The access control module 102 may then control a function of the mobile device 16 based on the identified rule 112.

Although the illustrated embodiment shows a separate rule database 104 and location database 108, in some embodiments, these databases may be combined in a single database accessible to one or more of the access control module 102 and the detection module 106. In further embodiments, each seat zone 110 included in the rule database 104 may include the one or more angles and/or distance values for the seat zone 110 relative to the phased array antenna 64. The location database 108 may be omitted in this embodiment, and upon collecting measurement data for a given mobile device 16, the detection module 106 may provide the measurement data to the access control module 102, which may then determine the relevant rule 112 directly from the measurement data by querying the rule database 104 based on the measurement data. In other words, rather than including an identification of a seat zone 110, the determined location of a mobile device 16 may include the measurement data collected by the detection module 106. Further in this embodiment, the rule database 104 may be coupled to both the access control module 102 and the detection module 106.

In operation, the access control module 102 may receive a weight change signal 114, such as from the seat occupancy sensors 26, in response to a person sitting or leaving a seat of the vehicle 12. The access control module 102 may also generate a mobile device control signal 115 that may be transmitted to a mobile device 16 to control a function thereof in accordance with a rule 112. The detection module 106 may generate antenna control signals 116 to direct control of the phased array antenna 64, and likewise may receive antenna data 118 that is received by the phased array antenna 64 from a mobile device 16.

FIG. 8 illustrates a process 200 and may be performed by the processing architecture 100. The process 200 may include determining a location of a mobile device 16 within the vehicle 12 relative to the vehicle 12 based on one or more signals wirelessly transmitted to the mobile device 16 from the antenna unit 28 and/or one or more signals wirelessly transmitted from the mobile device 16 to the antenna unit 28. In particular, a seat-related location may be identified for a mobile device 16 based on at least an angle of a signal received from the mobile device 16 at the antenna unit 28. Thereafter, the process 200 may include controlling a function of the mobile device 16 based on the determined location.

In block 202, a seat occupancy transition may be detected. In particular, a weight increase in any one of the seats of the vehicle 12 may indicate that a person with a mobile device 16 has recently sat in that seat. Accordingly, in response to a weight increase on one of the seats of the vehicle 12, the seat occupancy sensors 26 for that seat may generate a weight change signal 114 indicative of the weight increase at the seat. In some embodiments, the seat occupancy sensors 26 may transmit the weight change signal 114 to the access control module 102, which may then send a corresponding signal to the detection module 106. In alternative embodiments, the seat occupancy sensors 26 may transmit the weight change signal 114 directly to the detection module 106.

In block 204, responsive to the seat occupancy being detected, the detection module 106 may broadcast a reference signal 72 throughout the interior cabin 80 of the vehicle 12. In particular, the detection module 106 may transmit one or more antenna control signals 116 to the phased array antenna 64 that cause the phased array antenna 64 to broadcast the reference signal 72. The reference signal 72 may then be received by any mobile device 16 within range of the reference signal 72, which may include mobile devices 16 both inside and outside of the vehicle 12. In some embodiments, the reference signal 72 may include a reference frequency that is in the 60 GHz band or in the millimeter wave band. In other words, the wavelength of the reference signal 72 may be measured in millimeters (e.g., about 5 mm).

In addition, or alternatively, to broadcasting the reference signal 72 in response to detection of a seat occupancy, the detection module 106 may be configured to cause the antenna unit 28 to periodically broadcast the reference signal 72. As a further additional or alternative option, the detection module 106 may be configured to cause the antenna unit 28 to automatically broadcast the reference signal 72 when a mobile device 16 is powered on and enters the vehicle, which may be indicated when a new mobile device 16 is connected to the ACS 14 via Bluetooth or Wi-Fi.

For each mobile device 16 in range of the reference signal 72, responsive to receiving the reference signal 72, the mobile device 16 may advertise a mobile device beacon, such as an omni-directional mobile device beacon 76 or a directional mobile device beacon 71 pointed in the direction of the reference signal 72, that includes information for connecting to the mobile device 16 and that is received by the phased array antenna 64. In block 206, the detection module 106 may detect or receive the mobile device beacon transmitted from a mobile device 16 in the interior cabin 80 in response to receiving the reference signal 72, such a via the phased array antenna 64. As is further explained below, the detection module 106 may utilize the mobile device beacon to determine a seat-related location of the mobile device 16 within the vehicle 12.

More particularly, after broadcasting the reference signal 72, the detection module 106 may cause phased array antenna 64 to begin scanning for mobile device beacons based on additional antenna control signals 116 received from the detection module 106. The additional antenna control signals 116 may cause the phased array antenna 64 to implement several directed receivers that are focused onto various sections of the interior cabin 80 of the vehicle 12. As described above, the detection module 106 may scan particular sections of the cabin 60 by applying particular phase shifts to signals received at the phased array antenna 64, and thereafter combining the received signals to determine if a mobile device beacon is present in a given direction. In some embodiments, the detection module 106 may cause the phased array antenna 64 to scan a portion of the interior cabin 80 for a mobile device beacon and upon the detection module 106 determining that at least one mobile device beacon exists in that portion, may divide the portion into smaller portions to scan. In this way, the detection module 106 is able to resolve the location from which the mobile device beacon originates to a higher degree. The detection module 106 and antenna unit 28 may be capable of scanning the entire interior cabin 80 of the vehicle 12 for mobile device beacons in about one millisecond.

In block 208, the detection module 106 may determine one or more device angles (e.g., the azimuth and zenith angles) for a mobile device 16 relative to the phased array antenna 64 based on an angle of the mobile device beacon received from the mobile device 16 relative to the phased array antenna 64. Specifically, responsive to receiving antenna data 118 that indicates a mobile device beacon transmitted by a mobile device 16, the detection module 106 may note the direction of the receiving antenna formed by the phased array antenna 64 that received the mobile device beacon, and thus the angle of the received signal. In other words, the detection module 106 may determine the one or more device angles based on the phase shifts applied to the signals received by the phased array antenna 64 when the mobile device beacon is detected. The detection module 106 and/or access control modules 102 may utilize the one or more device angles to determine the seat-related location of the mobile device 16.

In some embodiments, the one or more device angles determined for a mobile device 16 based on an angle of a signal received from the mobile device 16 may be calculated based on the antenna configuration or phase shifts that were applied when the mobile device beacon was received, or may be retrieved from a database, such as the location database 108, that links the antenna configuration or phase shifts to the one or more device angles. Alternatively, the one or more device angles determined for a mobile device 16 based on an angle of a single received from the mobile device 16 may be the antenna configuration or phase shifts that were applied when the mobile device beacon was received. This may occur when the antenna configuration or phase shifts are directly linked within the location database 108 to a seat zone 110 or within the rule database 104 to a rule 112.

In block 210, a connection may be formed with each mobile device 16 detected by the scan. In particular, the detection module 106 may cause the phased array antenna 64 to transmit a beam 70 to each of the mobile devices 16 based on the mobile device beacon received from the mobile device 16, or more specifically based on the one or more device angles determined for the mobile device 16. In other words, the phased array antenna 64 may transmit the beam 70 to each mobile device 16 in a direction corresponding the direction from which the mobile device beacon for the mobile device 16 was received. The beam 70 may form a communications channel between the antenna unit 28 and/or ACS 14 and the mobile device 16. The antenna unit 28 may transmit beams 70 to multiple mobile devices 16, and may thereby form multiple communication channels with multiple mobile devices 16. Because each beam 70 is confined to a narrow beam, man-in-the middle attacks become rather difficult. Once the connection is formed, each mobile device 16 may form a level two network with the other elements of the vehicle computing environment 10, such as the ACS 14 and/or antenna unit 28. Additionally, all of the mobile devices 16 may be on a same network, and may be able to access each other independently of the ACS 14 and/or antenna unit 28.

In some embodiments, the beam 70 may include a communications frequency that differs from the reference frequency of the reference signal 72. Nevertheless, the beam 70 may be in the 60 GHz band or the millimeter wave band such that the wavelength of the beam 70 can be measured in millimeters (e.g., about 5 mm). As discussed below, the location of each mobile device 16 may then be determined based on the reference signal 72 and the beam 70 associated with the mobile device 16.

In block 212, for each mobile device 16, the detection module 106 may receive a phase difference (i.e., phase delay) between the beam 70 sent to the mobile device 16 and the reference signal 72, such as via the phased array antenna 64. In particular, responsive to receiving a beam 70, each mobile device 16 may be configured to determine and transmit a signal to the phased array antenna 64 that includes an identification of the phase difference, such as via a modulated carrier signal, which may enable the detection module 106 to determine a location of the mobile device 16 within the vehicle 12. The phased array antenna 64 may pass the received signal to the detection module 106, which may then extract a coded signal from the received signal that includes the phase difference. As described in more detail below, the detection module 106 may utilize the phase difference to determine the seat-related location of each mobile device 16 within the vehicle.

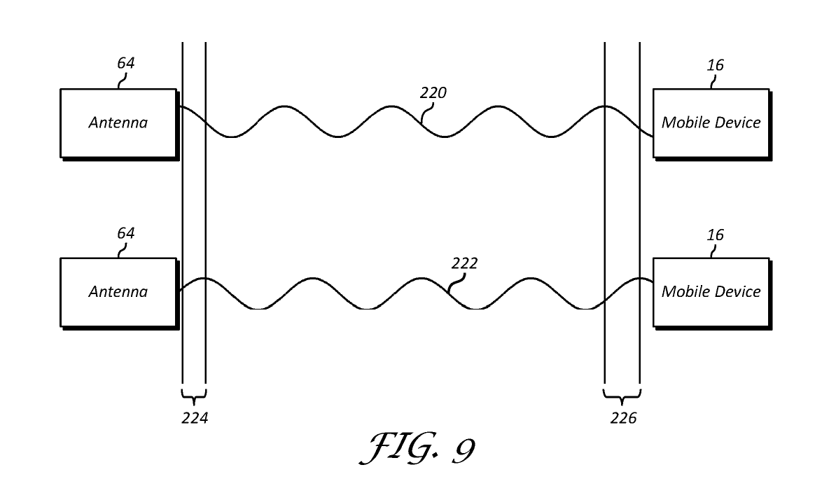

In block 214, the detection module 106 may determine a device distance for each mobile device 16, which may also be utilized to identify the seat-related location of the mobile device 16 within the vehicle 12. Specifically, the detection module 106 may determine a device distance between the phased array antenna 64 and the mobile device 16 using interferometric calculations, which may be based on the received phase difference, the reference frequency of the reference signal 72, and the communications frequency of the beam 70 for the mobile device 16. Referring to FIG. 9, for example, the antenna 64 may send a signal 220 to the mobile device 16, which may be the reference signal 72, and a signal 222 to the mobile device 16, which may be one of the beams 70. The mobile device 16 may determine a phase difference 226, or Δφᵣₓ, between signal 220 and 222 at the mobile device 16, thereafter transmit Δφᵣₓ to the detection module 106 via the antenna 64. The detection module 106 may also have knowledge of a phase difference 224, or Δφᵣₓ, at the antenna 64. Thereafter, the detection module 106 may determine a device distance between the antenna 64 and the mobile device 16 using the following formula:

$$Distance = \vert \frac{{Δϕ}_{tx} - {Δϕ}_{rx}}{{k}_{1} - {k}_{2}} \vert$$

where Δφᵣₓ is the phase difference 226 at the mobile device 16, Δφᵣₓ is the phase difference at the antenna 64, k₁ is the wave number (i.e., frequency divided by the speed of light) for the signal 220, and k₂ is the wave number for the signal 222.

In alternative embodiments, rather than utilizing interferometric methods as described above, the detection module 106 may determine the device distance between each mobile device 16 and the phased array antenna 64 by utilizing a time-of-flight method. In particular, the detection module 106 may start a timer contemporaneously with transmitting a device distance-finding signal, such as the reference signal 72, the beam 70, or some other signal sent into the interior cabin 80 and/or to the mobile device 16 for the purpose of determining device distance. The mobile device 16 may be configured with or include a predetermined processing delay for responding to the device distance-finding signal. Upon receiving the range-finding signal, and upon expiration of the predetermined processing delay after the device distance-finding signal is received, the mobile device 16 may transmit a responsive signal, such as the mobile device beacon described above, which may be received by the phased array antenna 64. The responsive signal may thereafter enable the detection module 106 to determine the location of the mobile device 16 with the vehicle. Specifically, upon receiving the responsive signal, the detection module 106 may be configured to stop the timer, and may determine a device distance between the mobile device 16 and the phased array antenna 64 based on a value of the timer when the responsive signal is received (which may be equal to or greater than the time of flight of the device distance-finding signal, the processing delay, and the time of flight of the responsive signal) and the predetermined processing delay for the mobile device 16 to transmit the responsive signal after the device distance-finding signal is received by the mobile device. Specifically, the detection module 106 may compute the range using the following formula:

$$Distance = \frac{( t - p ) * c}{2}$$

where t is the time tracked by the timer, p is the predetermined processing time for the mobile device 16, immediately after receiving the distance-finding signal, to process and respond to the signal, and c is the speed of light. As explained below, the detection module 106 may determine the seat-related location of the mobile device 16 based on the device distance.

In block 216, the seat-related location of each mobile device 16 may be determined. Specifically, the detection module 106 may determine the location of each mobile device 16 based on the one or more device angles determined for the mobile device 16 relative to the phased array antenna 64 and/or the device distance between the phased array antenna 64 and the mobile device 16. To this end, the detection module 106 may query the location database 108 based on the one or more device angles and the distance. In response, the location database 108 may return to the detection module 106 an indication of a seat zone 110 in the record for which the one or more angles include the measured device angles, and/or for which the one or more distance values include the device distance. In other words, the location database 108 may return an indication of a seat zone 110 that is associated with the one or more device angles and device distance within the location database 108. The determined seat-related location of the mobile device 16 may therefore include the identified seat zone 110.

As previously described, in other embodiments, the detection module 106 may determine the location the of a mobile device 16 based on the one or more device angles determined for the mobile device 16 and/or the device distance for the mobile device 16 by virtue of including one or more of these items in the device location. In other words, the determined location for a mobile device 16 may include the one or more device angles and/or the device distance of the mobile device 16.

In some embodiments, the detection module 106 may determine the location of the mobile device 16 based on the one or more device angles and without directly measuring device distance. For example, two beam-forming antennas may be placed within the vehicle, and four coordinates may be resolved for a mobile device 16 relative to the two antennas via the methods described above (e.g., {θ,ϕ} relative to each antenna). The detection module 106 may triangulate the location of the mobile device 16 based on these coordinates that the distance between the antennas. As a further example, the configuration of the vehicle 12 may be such that the one or more angles ranges for each seat zone 110 relative the phased array antenna 64 do not overlap with those of another seat zone 110. For example, this configuration may occur when the vehicle 12 includes two or less rows of seats, and the phased array antenna 64 is located at or around a center of the interior cabin 80. In these cases, the one or more device angles of each mobile device 16 relative to the phased array antenna 64 are enough for the detection module 106 to identify the seat zone 110 of the of the mobile device 16. Accordingly, each seat zone 110 in the aforementioned databases may be associated with or include one or more angles and not a distance, and a query sent to the databases may include one or more device angles and not a device distance.

In block 218, responsive to determining the seat-related location of each mobile device 16, the access control module 102 may control a function of each mobile device 16. In particular, the detection module 106 may pass the determined location for each mobile device 16 (e.g., seat zone 110, device angles and device range) to the access control module 102, which may then query the rule database 104 to identify a rule 112 that is associated with the determined location for the mobile device 16. The identified rule 112 may include one or more limitations and/or allowances for the determined location. Thereafter, the access control module 102 may implement the limitations and allowances for the mobile device 16, such as by transmitting one or more signals to the mobile device 16 that indicate the allowances and/or limitations via Bluetooth, Wi-Fi, and/or the phased array antenna 64. In response to receiving the one or more signals, the mobile device 16, such as via the operating system 42 or an application 44 installed thereon, may enable a user to perform actions according to the allowances and disable the user from performing actions according to the limitations via the mobile device 16.

For example, a particular rule 112 may associate a particular location with a particular one of a plurality of climate zones offered by the HVAC system 22 of the vehicle 12. Thus, for a mobile device 16 that is located in the particular climate zone, the mobile device 16 may be determined as being located in the particular location associated with the particular climate zone. Thereafter, the access control module 102 may query the rule database 104 for the particular rule 112 indicating the particular determined location and the particular climate zone, and enable the mobile device 16 to control the particular climate zone and not any of the other climate zones offered by the HVAC system 22. For example, the access control module 102 may transmit a signal to the mobile device 16 that corresponds to the particular rule 112, and responsive to receiving the corresponding signal, the mobile device 16 may enable a user to control the particular climate zone and not the other climate zones via the mobile device 16.

As a further example, a particular location may be associated with a driver's seat location, such as via a rule 112, and a rule 112 may indicate that a display of a mobile device 16 in the particular location should be disabled while the vehicle 12 is on or in motion. Accordingly, for a mobile device 16 determined as being located in the particular location associated with the driver's seat location, the access control module 102 may render a display of the mobile device 16 inoperative when the vehicle 12 is on or in motion, which may be determined by the vehicle 12 or by a movement detector installed on the mobile device 16. Specifically, the access control module 102 may transmit a signal corresponding to the particular rule 112 to the mobile device 16, which upon receipt of the signal may configure the mobile device 16 to determine whether the vehicle 12 is in on or motion, and if so, then prevent the display of the mobile device 16 from illuminating. Alternatively, the access control module 102 may transmit a signal corresponding to the particular rule 112 to the mobile device 16 whenever the access control module 102 determines that the vehicle 10 is in motion, and upon receipt of the signal, the mobile device 16 may prevent its display from illuminating.

In another example, a particular location may be associated with a front seat location (e.g., a front seat passenger location and/or driver's seat location), such as via a rule 112, and a rule 112 may indicate that a mobile device 16 in the particular location is allowed to enter a destination into the navigation system 20 of the vehicle 12 via the mobile device 16 (possibly with the caveat that the vehicle 10 not be in motion for the driver's seat location). Accordingly, for a mobile device 16 determined as being located in the particular location, the access control module 102 may enable the mobile device 16 to enter a destination into the navigation system 20 via the mobile device 16, such as by transmitting a corresponding signal to the mobile device 16. Similarly, a particular location may be associated with a backseat location, such as via a rule 112, and a rule 112 may indicate that a mobile device 16 located in the particular location is not allowed to enter a destination into the navigation system 20 of the vehicle 12 via the mobile device 16. Accordingly, for a mobile device 16 determined as being located in the particular location, the access control module 102 may prevent the mobile device 16 from entering a destination into the navigation system 20 via the mobile device 16, such as by transmitting a corresponding signal to the mobile device 16 or not enabling the mobile device 16 with such functionality.

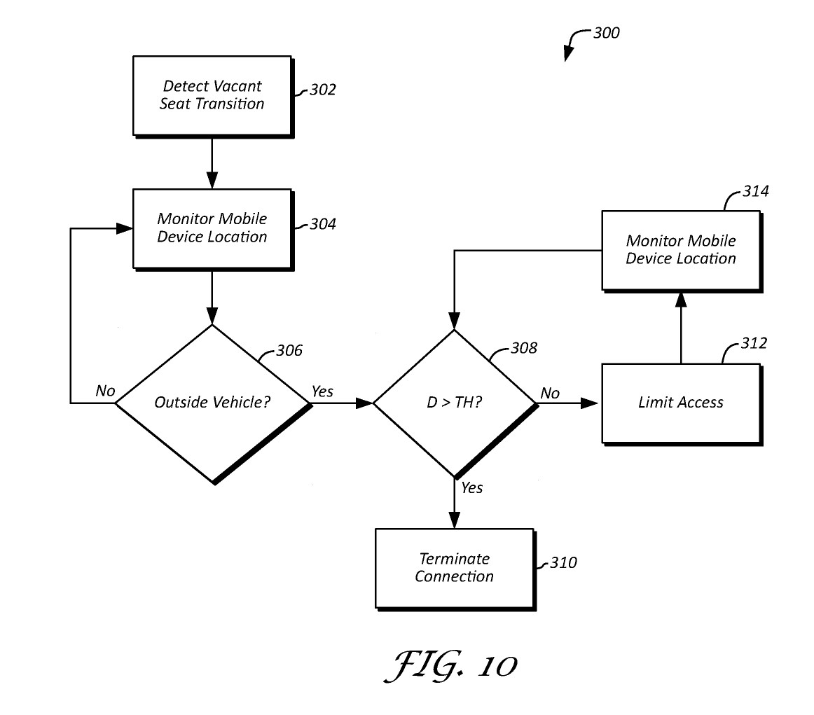

FIG. 10 illustrates a process 300 that may be performed by the processing architecture 100. The process 300 may include determining whether a mobile device 16 has left the vehicle 12, and thereafter monitoring a location of the mobile device 16 to determine when the mobile device 16 should be disconnected from the vehicle computing environment 10, or more particularly from the ACS 14 and/or antenna unit 28.

In block 302, a vacant seat transition may be detected. In particular, a weight decrease in any one of the seats of the vehicle 12, or alternatively a removal of all weight from any of the seats of the vehicle 12, may indicate that a person with a mobile device 16 has recently left the seat. Accordingly, in response to a weight decrease or removal on one of the seats of the vehicle 12, the seat occupancy sensors 26 for that seat may generate and transmit a weight change signal 114 to the access control module 102 indicative of the weight decrease or removal. Thereafter, the access control module 102 may pass a corresponding signal to the detection module 106. Alternatively, the seat occupancy sensors 26 may transmit the weight change signal 114 directly to the detection module 106 without going through the access control module 102.

In block 304, responsive to detecting a vacant seat transition, the detection module 106 may continuously monitor a location of one or more of the mobile devices 16. Specifically, the detection module 106 may measure one or more device angles and/or a device distance for each of the mobile devices 16 relative to the phased array antenna 64, such as via the above-described communication channels established between the antenna unit 28 and each of the mobile devices 16, and/or via the measurement techniques described above (e.g., applying phase shifts to received signals, interferometrics, time-of-flight). For each set of measured metrics, the detection module 106 may query one of the databases of the processing architecture 100, such as the location database 108 or the rule database 104, based on the measured metrics to determine whether the mobile device 16 is still in the vehicle 12.

In block 306, for each of the mobile devices 16, the detection module 106 may determine whether the mobile device 16 is outside the vehicle 12 based on the monitoring. If a mobile device 16 has left a vehicle, none of the seat zones 110 of the location database 108 or rule database 104 will match the metrics measured for the mobile device 16. Accordingly, in response to a query including the measured metrics, the rule database 104 or location database 108 may return an indication that there is no matching seat zone 110, and/or that the mobile device 16 is no longer in the vehicle 12.

Responsive to determining that a mobile device 16 still remains in the vehicle 12 (“No” branch of block 306), then in block 304, the detection module 106 may continue monitoring a location of the mobile device 16. Responsive to determining that a mobile device 16 is outside the vehicle 12 (“Yes” branch of block 306), then in block 308, the detection module 106 may determine whether the distance between the mobile device 16 and the vehicle 12 is greater than a preset distance threshold. For example, knowing the location of the phased array antenna 64, and one or more device angles of the of the mobile device 16 relative to the phased array antenna 64, the detection module 106 may determine the distance between the mobile device 16 and the vehicle 12 by querying the rule database 104 or the location database 108 based on the one or more device angles for a maximum distance between the phased the array antenna 64 and the seat zone furthest away from the phased array antenna 64 in a direction corresponding to the one or more device angles. Thereafter, the detection module 106 may subtract the maximum distance returned from the rule database 104 or the location database 108 from the monitored device distance between the phased array antenna 64 and the mobile device 16. If the result is greater than the preset threshold (“Yes” branch of block 308), then in block 310, the access control module 102 and/or the detection module 106 may terminate the connection between ACS 14 and/or antenna unit 28 and the mobile device 16.

In response to the mobile device 16 being less than the preset distance threshold from the vehicle 12 (“No” branch of block 308), then in block 312, the access control module 102 may limit vehicle access for the mobile device 16. Specifically, responsive to determining that a mobile device 16 has left the vehicle 12 but is not a preset distance threshold from the vehicle 12, the detection module 106 may provide a corresponding indication to the access control module 102, which may remove previous limitations and/or allowances applied to the mobile device 16. For example, if a mobile device 16 was previously enabled to control one or more climate zones based on its location, this allowance may be disabled by the access control module 102. As a further example, if the screen of the mobile device 16 was previously disabled when the mobile device 16 was moving due to the mobile device 16 being located in a driver's seat location, the access control module 102 may enable the screen to illuminate upon the mobile device 16 exiting the vehicle. The access control module 102 may remove previously applied limitations and/or allowances by transmitting a corresponding signal to the mobile device 16 via Bluetooth, Wi-Fi, and/or the phased array antenna 64, and/or by not processing commands (e.g., climate change commands) received form the mobile device 16.

In block 314, after vehicle access for the mobile device 16 has been limited, the detection module 106 may continue to monitor a location of the mobile device 16 as the mobile device 16 moves away from the vehicle 12. In particular, the detection module 106 may continue to monitor a location of the mobile device 16 relative to the phased array antenna 64 using the above-described techniques (e.g., phase shifts, interferometrics, time-of-flight). Thereafter, responsive to the mobile device 16 reaching or exceeding the preset distance threshold from the vehicle 12 (“Yes” branch of block 308), in block 310, the access control module 102 and/or the detection module 106 may terminate the connection with the mobile device 16.

In some embodiments, tracking mobile devices 16 as they enter and exit the vehicle 12 may be utilized for applications in which passengers have reserved seats on the vehicle 12. For example, upon booking a seat on a vehicle 12, a passenger may register his or her mobile device 16. Later, when the passenger boards the vehicle 12 at the start of his or her itinerary, the access control module 102 and/or detection module 106 may verify that the mobile device 16 registered for the passenger is present inside vehicle 12, and/or is located in a seat assigned to the passenger. At the end of the passenger's itinerary, the access control module 102 and/or detection module 106 may verify that the mobile device 16 registered for the passenger exits the vehicle 12. If one of these checks fail, then the access control module 102 and/or detection module 106 may notify the driver of the vehicle 12, or some other person associated with operation of the vehicle 12, that a passenger may be missing from the vehicle 12, may be in the wrong seat, or may have not exited the vehicle 12 at the end of his or her itinerary.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

Various program code described herein may be identified based upon the application within that it is implemented in specific embodiments of the invention. However, it should be appreciated that any particular program nomenclature that follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts, sequence diagrams, and/or block diagrams. The computer program instructions may be provided to one or more processors of a special purpose computer, or other programmable data processing apparatus to produce a machine, such that the instructions, which execute via the one or more processors, cause a series of computations to be performed to implement the functions, acts, and/or operations specified in the flowcharts, sequence diagrams, and/or block diagrams.

In certain alternative embodiments, the functions, acts, and/or operations specified in the flowcharts, sequence diagrams, and/or block diagrams may be re-ordered, processed serially, and/or processed concurrently consistent with embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes,” “having,” “has,” “with,” “comprised of,” or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

1. A vehicle system comprising:
at least one processor configured to, responsive to identifying a seat-related location for a mobile device based on an angle of a first signal received from the mobile device, permit the mobile device to control a first climate zone of the vehicle that is for the seat-related location and not a second climate zone of the vehicle.

2. The vehicle system of claim 1, wherein the seat-related location comprises a front seat passenger location, and the at least one processor is further configured to, responsive to identifying the seat-related location for the mobile device, permit the mobile device to enter a destination into a navigation system of the vehicle.

3. The vehicle system of claim 1, wherein the seat-related location comprises a backseat location, and the at least one processor is further configured to, responsive to identifying the seat-related location for the mobile device, prevent the mobile device from entering a destination into a navigation system of the vehicle.

4. The vehicle system of claim 1, further comprising:
a multiple beam forming antenna that receives the first signal from the mobile device.

5. The vehicle system of claim 4, wherein the multiple beam forming antenna operates in a millimeter band.

6. The vehicle system of claim 1, wherein the at least one processor is further configured to identify the seat-related location for the mobile device responsive to a weight increase being detected on a seat of the vehicle.

7. The vehicle system of claim 1, wherein the at least one processor is further configured to identify the seat-related location based on a distance between the mobile device and an antenna of the vehicle that is derived from a phase delay between a second signal and a third signal sent to the mobile device from the antenna.

8. The vehicle system of claim 7, wherein the at least one processor is further configured to, responsive to a distance between the mobile device and the vehicle exceeding a preset threshold, terminate a connection between the mobile device and the vehicle.

9. A system comprising:
a vehicle configured to
responsive to a seat weight increase, scan an interior of the vehicle to identify a first seat-related location for a mobile device that is associated with a driver's seat of the vehicle based on an angle of a signal received from the mobile device; and
responsive to identifying the first seat-related location and to the vehicle being in motion, prevent a display of the mobile device from illuminating.

10. The system of claim 9, wherein the first seat-related location is associated with a first climate zone, and the vehicle is further configured to enable the mobile device to control the first climate zone and not a second climate zone of the vehicle.

11. The system of claim 9, wherein the vehicle is further configured to
responsive to identifying the first seat-related location, or a second seat-related location for the mobile device that is associated with a front passenger seat of the vehicle, enable the mobile device to enter a destination into a navigation system of the vehicle, and
responsive to identifying a third seat-related location for the mobile device that is not the first seat-related location or the second seat-related location, prevent the mobile device from entering a destination into the navigation system of the vehicle.

12. The system of claim 9, further comprising:
a multiple beam forming antenna that receives the signal from the mobile device.

13. The system of claim 12, wherein the multiple beam forming antenna operates in a millimeter band.

14. (canceled)

15. The system of claim 9, wherein the vehicle is further configured to identify the first seat-related location based on a distance between the mobile device and an antenna of the vehicle that is derived from a phase delay between a second signal and a third signal sent to the mobile device from the antenna.

16. The system of claim 15, wherein the vehicle is further configured to, responsive to the distance between the mobile device and the vehicle exceeding a preset threshold, terminate a connection between the mobile device and the vehicle.

17. A method comprising:
by a vehicle
broadcasting, from a phased array antenna mounted on a vehicle headliner, a reference signal into a vehicle interior cabin;
identifying seat-related locations for mobile devices based on an angle of a signal received at the antenna from each mobile device responsive to the reference signal; and
responsive to identifying the seat-related locations, preventing a first of the mobile devices from entering a destination into a vehicle navigation system.

18. The method of claim 17, further comprising:
responsive to identifying the seat-related locations, permitting a second of the mobile devices to enter a destination into the vehicle navigation system.

19. The method of claim 18, wherein the seat-related locations comprise a backseat location of the vehicle for the first mobile device and a front seat location of the vehicle for the second mobile device.

20. The method of claim 17, wherein the seat-related locations comprise a driver's seat location for the first mobile device, and further comprising, responsive to the vehicle being in motion and to identifying the seat-related locations for the mobile devices, preventing a display of the first mobile device from illuminating.

21. The method of claim 17, further comprising:
responsive to identifying that the first mobile device has left the vehicle and is within a predetermined distance of the vehicle
removing a limitation or allowance previously applied to the first mobile device; and
continuing to monitor a location of the first mobile device, and
responsive to identifying that the first mobile device has left the vehicle and is not within the predetermined distance of the vehicle, terminating a connection with the first mobile device.
